(19) United States
(12) Patent Application Publication
(10) Pub. No.: US 2025/0086722 A1
(43) Pub. Date: Mar. 13, 2025

(54) SYSTEMS AND METHODS FOR RAPID INDEX GENERATION FROM COORDINATE-BASED DATA TAGS

(71) Applicant: Syntax LLC, New York, NY (US)

(72) Inventor: Patrick Shaddow, Ridgewood, NJ (US)

(73) Assignee: Syntax LLC, New York, NY (US)

(21) Appl. No.: 18/421,983

(22) Filed: Jan. 24, 2024

Related U.S. Application Data
(60) Provisional application No. 63/582,237, filed on Sep. 12, 2023.

(51) Int. Cl. G06Q 40/06; G06F 16/22

(52) U.S. Cl. CPC G06Q 40/06; G06F 16/2228

(57) ABSTRACT

The subject methods and systems comprise data processes and analytics enabling the development of metrics to assess complex systems, including index-based methodologies customized to user preferences. Indices can be rapidly generated by using coordinate-based data tags in the conversion of qualitative measures to quantitative metrics and applying analytical methods to those metrics with customized exposures, including to thematic, sectoral, product, and environmental measures.

### CROSS-REFERENCE TO RELATED APPLICATION

This application claims priority to and the benefit of U.S. Provisional Patent Application No. 63/582,237, filed Sep. 12, 2023, and titled “Systems and Methods for Rapid Portfolio Optimization from Coordinate-Based Data Tags”, the contents of which are incorporated by reference in its entirety herein.

### TECHNICAL FIELD

The present application generally relates to the field of data and technology systems for optimizing and customizing indices created from quantified and unified data sources.

### BACKGROUND

Individuals and small businesses seeking to advance their objectives by investing confront numerous challenges, including, but not limited to, the effects of macroeconomic factors and geopolitical events on financial markets, high costs of quality financial information and software, lack of access to sophisticated trading systems and techniques, excessive fees on many financial products, challenges in forecasting future investment performance and financial needs, tax management challenges, difficulties in market timing, and behavioral factors.

These factors, among others, have led retail investors, as a category, to substantially underperform broad-market index funds and random investment decision-making over the long term, impeding individuals from achieving their housing, retirement, healthcare, and educational objectives and at once straining the budgets and negatively impacting the financial soundness of governments seeking to remedy these matters at scale through monetary and fiscal policy.

Prior financial technology platforms available to retail investors have not sufficiently addressed underlying data and behavioral challenges and have not generally led to strong investor performance; in certain cases, the tendency of prior such platforms to prioritize trends over investment soundness have contributed to market volatility and significant losses of capital.

While ETFs have enabled retail investors to access diversified investments, generally at lower cost than mutual funds, they have failed to address most of the other underlying challenges contributing to poor investor performance. In certain instances, their widespread use may also have contributed to reducing market efficiency by increasing the correlation among constituents of broadly held ETFs.

Vehicles using advanced customization, security selection, and tax management features are still largely restricted to institutions, as well as high-net worth individuals through separately managed accounts. Existing technological systems for index and portfolio construction are often insufficiently transparent, flexible, rules-based, deterministic, precise, auditable, and replicable, making it difficult for users to design, implement and manage products consistent with user goals. These challenges contribute to widespread reliance on broad-based, non-customizable products. Trillions of dollars are concentrated in the most widely held ETFs, which are neither tailored to user needs, nor necessarily suited for all market environments.

The lack of advanced data systems configured for leveraging disparate data sources for qualitative economic and financial analysis that are broadly available and accessible further impedes individuals from achieving their financial objectives. Thus, there is a need for an investment platform that enable the rapid creation of customized portfolios at scale for the average investor.

### SUMMARY

A computational method and system and platform for algorithmically generating indices aligned with user preferences using coordinate-based data structures is disclosed. The platform includes data models to render qualitative data associated with complex systems quantitatively and integrate it with quantitative data to facilitate rapid search, retrieval, similarity scoring, and testing.

The platform enables the generation of indices that are rules-based, transparent, and auditable. The algorithms and data structures facilitate the flexible and rapid generation of indices that accurately and precisely reflect user preferences and are consistent with target outcomes.

Embodiments include computerized methods, systems, and computer-readable media for creating a customized index, the method comprising: storing data from multiple disparate data sets, the disparate data sets including both qualitative properties and quantitative properties associated with the data entities; selecting an algorithm that renders qualitative properties quantitatively; applying the selected algorithm to the qualitative properties to convert the qualitative properties into quantitative data; selecting a data structure that unifies quantitative data associated with the disparate data sets; applying the data structure to integrate the quantitative data with the quantitative properties associated with the data entities, thereby creating a unified quantitative data set; associating the data entities with the unified quantitative data set with a logical database structure; receiving index construction parameters associated with a user; selecting a generative algorithm that combines data entities associated with quantitative data; applying the generative algorithm to the unified quantitative data set to create a customized index of data entities; and storing the customized index of data entities in a database.

In further embodiments, the index construction parameters are qualitative and quantitative, further comprising: algorithmically computing a similarity metric between the index construction parameters and the unified quantitative data set; providing the similarity metric as an input to the generative algorithm; selecting a second algorithm that renders qualitative properties quantitatively; applying the second algorithm to the qualitative index construction parameters to convert the qualitative properties into a second set of quantitative data; selecting a second data structure that unifies quantitative data associated with disparate data sets; applying the second data structure to integrate the second set of quantitative data with the quantitative index construction parameters, thereby creating a second unified quantitative data set; and algorithmically computing a second similarity metric between the first unified quantitative data set and the second unified quantitative data set.

Further embodiments include algorithmically computing a third similarity metric between the customized index of data entities and the second unified quantitative data set; verifying that the third similarity metric is greater than the second similarity metric under fluctuations in parameters associated with the qualitative properties and quantitative properties, as determined by a test of statistical significance.

In further embodiments, the customized index is a financial index; the data entities represent investment securities; a plurality of the quantitative properties are selected from among market metrics, financial metrics, financial ratios, and economic metrics; and a plurality of the qualitative properties are selected from among sector, industry, geography, theme, environmental sustainability, social sustainability, governance, and economic properties.

Further embodiments include algorithmically converting the unified quantitative data set into a matrix, network, or high-dimensional coordinate data structure.

Further embodiments include applying a data structure based on ordinal coding or interval variables as an input to the algorithm that renders qualitative properties quantitatively, wherein the ordinal coding or interval variables are based on relationships modeled in an underlying system.

Embodiments include computerized methods, systems, and computer-readable media for creating a customized index, the system comprising a computerized processor configured for: storing data from multiple disparate data sets, the disparate data sets including both qualitative properties and quantitative properties associated with the data entities; selecting an algorithm that renders qualitative properties quantitatively; applying the algorithm to the qualitative properties to convert the qualitative properties into quantitative data; selecting a data structure that unifies quantitative data associated with disparate data sets; applying the data structure to integrate the quantitative data with the quantitative properties associated with the data entities, thereby creating a unified quantitative data set; associating the data entities with the unified quantitative data set with a logical database structure; receiving index construction parameters associated with a user; selecting a generative algorithm that combines data entities associated with quantitative data; applying the generative algorithm to the unified quantitative data set to create a customized index of data entities; and storing the customized index of data entities in a database.

In further embodiments, the index construction parameters are qualitative and quantitative, further comprising instructions for: algorithmically computing a similarity metric between the index construction parameters and the unified quantitative data set; providing the similarity metric as an input to the generative algorithm; selecting a second algorithm that renders qualitative properties quantitatively; applying the second algorithm to the qualitative index construction parameters to convert the qualitative properties into a second set of quantitative data; selecting a second data structure that unifies quantitative data associated with disparate data sets; applying the second data structure to integrate the second set of quantitative data with the quantitative index construction parameters, thereby creating a second unified quantitative data set; and algorithmically computing a second similarity metric between the first unified quantitative data set and the second unified quantitative data set.

Further embodiments include: algorithmically computing a third similarity metric between the customized index of data entities and the second unified quantitative data set; and verifying that the third similarity metric is greater than the second similarity metric under fluctuations in parameters associated with the qualitative properties and quantitative properties, as determined by a test of statistical significance.

In further embodiments, the customized index is a financial index; the data entities represent investment securities; a plurality of the quantitative properties are selected from among market metrics, financial metrics, financial ratios, and economic metrics; and a plurality of the qualitative properties are selected from among sector, industry, geography, economic, theme, environmental, social, and governance properties.

Further embodiments include instruction for algorithmically converting the unified quantitative data set into a matrix, network, or high-dimensional coordinate data structure.

Further embodiments include instructions for applying a data structure based on ordinal coding or interval variables as an input to the algorithm that renders qualitative properties quantitatively, wherein the ordinal coding or interval variables are based on relationships modeled in an underlying system.

Embodiments include computerized methods, systems, and computer-readable media for creating a customized index of investment securities, comprising the steps of: storing financial data from multiple disparate data sets; extracting information concerning a set of investment securities from a database, said information being obtained from the disparate data sets, the disparate data sets including both qualitative and quantitative properties associated with the investment securities; converting the qualitative properties to quantitative properties by an ordinal coding technique; unifying the disparate data sets into a unified data set of quantitative properties associated with the investment securities; associating the investment securities with the unified quantitative properties within a logical database structure; receiving user-configured index construction parameters; determining the composition of a subset index of investment securities; constructing a customized index of investment securities based on the user-configured portfolio construction parameters; and storing the customized index of investment securities in an index database.

### BRIEF DESCRIPTION OF THE DRAWINGS

FIG. 1 illustrates an example system for generating an index from coordinate-based tags.

FIG. 2 illustrates example modules supporting a system for generating an index from coordinate-based tags.

FIG. 3 illustrates an illustrates an example ordered set of fields showing relationships between the fields.

### DETAILED DESCRIPTION

In various embodiments, a computer-implemented method, computing device, and computer-readable storage media are disclosed.

In one embodiment, a set of tags are applied to data entities; as non-limiting examples, the data entities may represent securities or economic entities, and the tags may be syntactic, semantic, functional, qualitative, or quantitative. In certain embodiments, the tags can be rendered, as non-limiting examples, in coordinate, graph, or matrix forms to facilitate computational operations.

The tags, in some embodiments, may enhance search, retrieval, and optimization operations on the data entities. In certain embodiments, the methods and systems described herein may enhance the capacity to optimize rapidly a set of parameters denoting data entities representing entities associated with a complex system, including, as a non-limiting example, securities associated with a financial system or economic system.

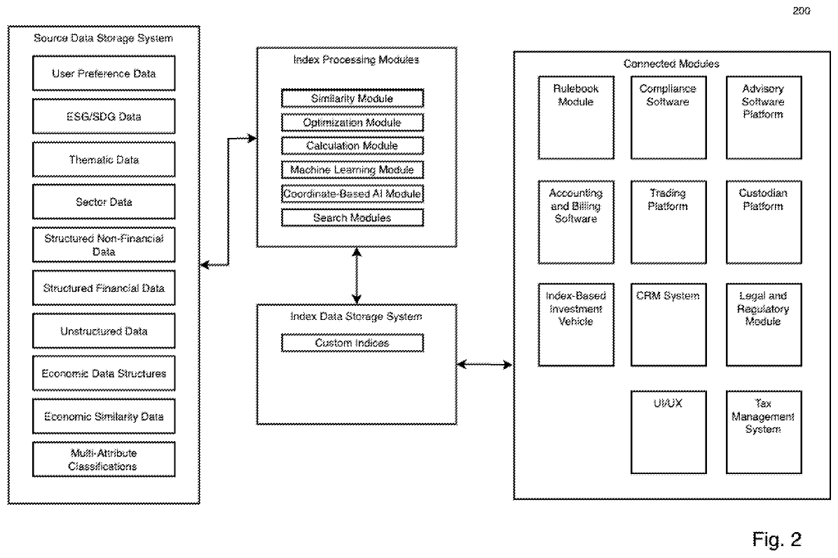

With reference to FIG. 2, in one embodiment of a platform, a set of modules are defined, created and linked enabling the development of indices. In one embodiment, as non-limiting examples, the modules may comprise the following:

Data modules, including, as non-limiting examples: modules for unstructured data and structured financial data; structured economic data; environmental social, governance, or developmental data; structured sector data thematic data; index data, data input, and data output.

Technical modules, including, as non-limiting examples, modules for coordinate-based artificial intelligence, economic data structures, similarity algorithms, machine learning techniques for classification, index generation, and rulebook generation.

Additional index modules, including, as non-limiting examples index selection, thematic indices, core indices, benchmark indices, ESG indices, impact indices, and factor indices; sectoral selection; and thematic overlays.

Additional quantitative modules, including, as non-limiting examples, modules for factor weighting, performance optimization, and/or tax management.

Additional operational modules, including, as non-limiting examples, modules for trading, accounting, billing, customer relationship management, advisory software, compliance, custody, legal, and regulatory.

In some embodiments, users are asked for express preferences concerning index generation. In other embodiments, user interactions with the platform generate revealed preferences to inform index generation. In other embodiments, both express preferences and revealed preferences inform index generation.

In one embodiment, a data and technology platform designed to enhance the capacity of users to achieve their financial objectives is described. In one embodiment, an analytical module may contain a set of data structures and algorithms to apply to data regarding complex systems; as a non-limiting example, the data structures and algorithms are designed to be applied to economic and financial systems.

In one embodiment, the platform may include a module of indices developed based on the data structures and algorithms as applied to economic and financial systems. As non-limiting examples, the indices may be weighted using stratified, factor-based, or standard market capitalization or equal-weight methodologies.

### Economic Data Structures

In one embodiment, an economic data structures module, as a non-limiting example, characterizes the transformation of economic inputs to outputs, enabling, as non-limiting examples, the more precise identification of themes, sectors, exposures, and product lines associated with securities than prior methods.

The economic data structures module, in one embodiment, is an input to and an output of an unstructured data module. In certain embodiments, the unstructured data module may include, as non-limiting examples, quantitative data, qualitative data, economic data, financial data, market data, index data, thematic data, environmental data, social data, governance data, sustainability data, developmental data, index data, user preference data, and data concerning sectors and themes.

As a non-limiting example, the unstructured data module may comprise a plurality of documents concerning, as non-limiting examples, economic, financial, and non-economic and non-financial characteristics, fundamentals, and performance.

In other embodiments, the unstructured data module comprises information in image, audio, or other media forms.

The platform, in one embodiment, includes a coordinate-based artificial intelligence (AI) module that reflects the proximity among, as non-limiting examples, parts, processes, or attributes in a complex system.

In one embodiment, the platform includes a machine learning techniques module that extracts data in a structured format from unstructured data.

In one embodiment, the machine learning techniques module and coordinate-based AI modules are applied to the unstructured data module to create a structured financial data module and a structured non-financial data module. As non-limiting examples, in certain embodiments, the structured financial data module may comprise sectoral, thematic, or product data as applied to investment securities that is more precise than prior systems. In one embodiment, the structured non-financial data module may comprise geographic, technological, environmental, social, or governance data that is more accurate than prior systems.

In one embodiment, the structured financial data and structured non-financial data are inputs to a multi-attribute classification database which characterizes, as non-limiting examples, investment securities in a multi-attribute format. As non-limiting examples, in certain embodiments, the classifications may be rendered in syntactic, semantic, network, coordinate, or matrix-based formats, permitting flexibility, as non-limiting examples, in computational analysis for, as non-limiting examples, search, retrieval, and product development.

In one embodiment, the economic data structures module is an input to a similarity algorithms module, which comprises techniques for determining the proximity in, as non-limiting examples, coordinate, syntactic, semantic, network, or matrix structures among a plurality of data entities, including, as non-limiting examples, securities.

In one embodiment, the similarity algorithms, as non-limiting examples, may be applied to the multi-attribute classification database and/or the economic similarity database to augment analysis of proximity and, as a non-limiting example, the development of indices based on similarity.

In one embodiment, as non-limiting examples, the structured financial data, structured non-financial data, multi-attribute classification database, and economic similarity database may be inputs to a cloud storage platform which aggregates data useful for the analysis of complex systems; as a non-limiting example, the cloud storage platform may be used to facilitate the more rapid development and optimization of indices based on investment securities.

In one embodiment, a search algorithm module comprises methods for information retrieval, including, as non-limiting examples, those designed or useful for the complex system being analyzed and the user platform in question, including, as non-limiting examples, financial or economic systems relevant for the development of indices based on securities.

### User Interface Module

In one embodiment, the platform seeks to determine a user's preferences with respect to index generation. As non-limiting examples, the platform may determine the user's preference from among benchmark, core, thematic, factor, impact, or pre-designed categories of indices. In other embodiments, other categories of indices are available to the user.

In some embodiments, the platform can solicit express user preferences. In other embodiments, the platform can determine index generation based on revealed user preferences. In additional embodiments, the platform can combine express preferences and revealed preferences to inform index generation.

Upon selection from a category of indices, in one embodiment, the platform seeks additional information associated with a user to facilitate index generation.

In another embodiment, a user interface module is provided to a plurality of users. The module, as non-limiting examples, may facilitate the determination of express and/or revealed user preferences, by tracking, as non-limiting examples, user responses to questions, user clicks and screen time on the platform, usage by the user of other linked platforms, and economic and financial data concerning the user.

### User Preference Module

In one embodiment, the user interface may be an input to and an output of a user preference data module, which aggregates user preferences for platform users.

In some embodiments, user preference data may include the extent of user conviction with respect to an option on the platform, including, as a non-limiting example, a thematic exposure.

In one embodiment, a thematic data module capturing thematic exposures is extracted from the cloud storage platform and/or the structured financial data and/or the structured non-financial data modules. As non-limiting examples, the thematic data modules may, in one embodiment, enable a user to focus an index on a macroeconomic or microeconomic area, including, as non-limiting examples, inflation sensitivity or cybersecurity, of investment interest to the user.

### ESG Data Module

In one embodiment, an ESG/SDG data module includes information extracted from the cloud storage platform and/or the structured non-financial data to reflect the correspondence of environmental, social, governance, sustainability, or developmental information with, as a non-limiting example, a set of economic entities and/or index constituents.

In certain embodiments, a set of the ESG or SDG properties may have magnitudes and directions such that they can be rendered as vectors in vector space, which may be rendered across multiple dimensions and have different effects in different geographic regions. As a non-limiting example, a company mining for cobalt used as an input to electric vehicle batteries may have a negative environmental impact associated with pollution in the region near the mine and a positive environmental impact associated with the reduction of carbon emissions in a region where electric vehicles are driven.

In one embodiment, the user preference data may be an input to and/or an output of the ESG/SDG data module, facilitating the rapid development, as a non-limiting example, of customized indices.

In one embodiment, a sector data module is an output of the cloud storage platform module, the structured financial data module, and/or the structured non-financial data module, and may include inputs from user preference data. As a non-limiting example, the sector data module may specify more precisely and/or rapidly than prior systems sectors to which a user can receive, as non-limiting examples, first, second, third, and/or higher-order exposures in a set of indices.

In one embodiment, an optimization module is an output, as a non-limiting example, of the structured financial data module. As a non-limiting example, in one embodiment the optimization module may enable the development of indices based on, as non-limiting examples, quantitative data; economic, financial, non-economic, and/or non-financial similarity; financial market data; and/or financial performance data that more accurately and/or rapidly replicate the performance of indices of securities with a limited number of constituents than third-party methods.

In one embodiment, a regulatory and legal module is included in the platform, which, as a non-limiting example, includes information related to taxation, financial index regulations, and securities laws.

In one embodiment, a tax management module is provided which, as a non-limiting example, may be an output of user preference data and/or the regulatory and legal module. As a non-limiting example, the tax management system may enable the more precise, accurate, or rapid application of trading methods customized to the needs of a user.

In one embodiment, a custom index module is included in the platform which takes as inputs, as non-limiting examples, user preference data, information from the tax management system, information from the optimization module, and information from the cloud storage platform to develop indices customized to user needs more rapidly and/or effectively according to one or more parameters than prior methods.

In one embodiment, an index-based investment vehicle module applies financial methods to implement the custom index as an investment product for the user.

In one embodiment, the index-based investment module provides data inputs to the advisory software platform module, which, as a non-limiting example, integrates other software tools, platforms, and modules to algorithmically provide, as a non-limiting example, investment services to a user.

In one embodiment, a trading platform module is an input to the advisory software platform. As non-limiting examples, the trading platform may comprise, in one embodiment, instructions to execute transactions and associated market data to facilitate the implementation of the index-based investment vehicle.

In one embodiment, a custodian platform module is an input to the advisory software platform module. As a non-limiting example, the custodian platform module may provide data, in one embodiment, concerning ownership by the user of securities that may be relevant to executing the trades relevant to implementing the index-based investment vehicle. In other embodiments, the custodian platform may include data concerning user purchases relevant to designing the custom indices.

In one embodiment, a customer relationship management (CRM) system module may be an input to the advisory software platform. As non-limiting examples, the CRM system module may provide information concerning users relevant to designing indices and implementing the index-based investment vehicle on the platform, and may, in certain embodiments, receive information concerning implementation of the custom indices. In one embodiment, an accounting and billing software module is an input to the advisory platform. As non-limiting examples, the accounting and billing software module may provide and/or receive financial data concerning the implementation of the index-based investment vehicle relevant to ongoing maintenance.

In one embodiment, an accounting and billing software module is an input to the advisory platform. As non-limiting examples, the accounting and billing software module may provide and/or receive financial data concerning the implementation of the index-based investment vehicle relevant to ongoing maintenance.

A compliance software module, in one embodiment, may be an input to the advisory software platform module. As a non-limiting example, the compliance software module may receive inputs from the regulatory and legal module to provide information relevant to maintaining the legal status of the implementation of the index-based investment vehicle.

In certain embodiments, a pre-specified set of indices are presented as customizable options to a user. A user may be presented, as non-limiting examples, with sectors or themes to overweight, underweight, or exclude in the customized version of an index selected by a user.

In another embodiment, security selection within sectors is determined, as a non-limiting example, by hierarchical stratification. In other embodiments, indices are constructed through stratification or stratified weighting.

In some embodiments, a user portfolio may be optimized to reduce the number of constituents in the final index created.

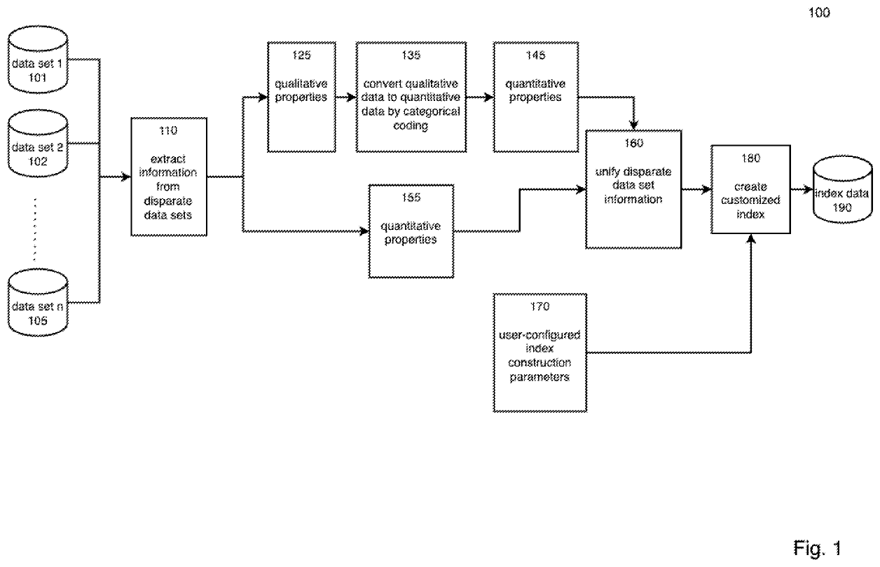

FIG. 1 illustrates a system that in certain embodiments may comprise an input to and an output of a custom index platform.

As used herein, a security is defined as a financial instrument that can represent, as non-limiting examples: an ownership position in a corporation (stock), a commodity, or a collection of assets; a securitized creditor relationship with an institution, such as a corporation, multilateral, or governmental body secured directly or indirectly by the assets of the issuer (bond); potential rights of purchase, sale, or ownership as represented by an option or other derivative instrument; a security interest in a commodity or real asset, including, as non-limiting examples, energy, timberland, and precious metals; a group of other securities pooled into a security, including, as non-limiting examples, a fund, exchange-traded fund, exchange-traded product, or structured product; or any collection thereof. A security may be a fungible, negotiable, financial instrument that represents a type of financial value associated with an economic entity. The company or economic entity that issues the security is known as the issuer. The value of the security value can be based on the type of security, the type of relationship with the issuer, and the type of assets and liabilities that are directly or indirectly associated with the security.

The methods described herein enable the calculation and implementation of weighting schemes for indices, and their constituents associated with securities, each of which have specific properties that are different from those of uncontrolled indices or portfolios of the same securities based on security or group-specific attributes. As described in more detail below, the invention, in one embodiment, uses a set of security-specific functional attributes that are syntactically and semantically related to constituents to reduce the index-level effects of the randomness of individual security returns by building indices of securities that reduce the impact of the exposures associated with functional attributes. In some embodiments, it does so by arranging attributes and their exposures in a controlled manner over a controlled index of population groupings, representing groupings defined by common attributes and groupings containing specific securities that share the attributes associated with the grouping.

### Functional Attributes

In some embodiments, functional attributes characterizing the economic entities enable the construction of indices from securities associated with those entities. As a non-limiting example, a syntax can be defined permitting the evaluation of expressions characterizing economic entities. In other embodiments, the syntax can be adapted to attributes selected by the user. In other embodiments, the user can be provided with an interface for creating new structures.

In some embodiments, a structure can be created from a Boolean statement in the form of ‘attribute’ ‘operator’ ‘value’ that may return true or false for an entity or its associated investment security based on its attributes. In other embodiments, a structure can be created a Boolean expression that combines (via Boolean operators) one or more statements. The ordered rules can also be expressed as a graph or network, which can be configured by enabling the population to be dynamically ordered based on functional attributes defined by the computerized system, the user, or a combination thereof.

Numerous attributes may be used to create an index architecture. The index architecture can include a nested structure of groups. As a non-limiting example, in some instances, these groups can be formed by referencing the attributes which are common to all entities in the universe, such that at each level, every element of the universe is in exactly one group. In some embodiments, these groups may be sub-divided into an arbitrary number of child sub-groups—and this sub-division process can be carried out an arbitrary number of times. In other embodiments, existing economic and financial classification schemes may be reconfigured using syntactic tagging to make them relational and dynamic, and be partially or wholly used in the portfolio architecture in combination with any or all of the universe selection, weighting, and reweighting, schemes described herein. Regardless of the construction method, the resultant index architecture can comprise an electronic representation of a set of attributes arranged, as non-limiting examples, in graphical, segmented, stratified, or network form, according to the defined attribute rules.

In one embodiment, a set of tags are applied to data entities; as non-limiting examples, the data entities may represent securities or economic entities, and the tags may be syntactic, semantic, functional, qualitative, or quantitative. In certain embodiments, the tags can be rendered, as non-limiting examples, in coordinate, graph, or matrix forms to facilitate computational operations.

The tags, in some embodiments, may enhance search, retrieval, and optimization operations on the data entities. In certain embodiments, the methods and systems described herein may enhance the capacity to optimize rapidly a set of parameters denoting data entities representing entities associated with a complex system, including, as a non-limiting example, securities associated with a financial system or economic system.

### Coordinate-Based Data Representations

In some embodiments, the platform uses methods of representing data in high-dimensional coordinate space to facilitate search, retrieval, distance scoring, and rapid index generation.

The computational analysis of a complex system, including, as non-limiting examples, an economy, a financial system, or an environmental system, may be facilitated by the application of data models that characterize, as non-limiting examples, properties, order, relationships, interactions, transformations, and structures in the system.

The data models may, as non-limiting examples, reflect input-output relationships, part-whole relationships, network interactions, or successive properties as interval variables or ordinal variables which can be encoded in a data structure.

The application of interval variables or ordinal variables enables the assignment of numerical codes whose order in the data model reflects order in the underlying complex system being modeled. As non-limiting examples, in one embodiment, the order may reflect temporal, spatial, mechanical, supplier-customer, component-final product, subsidiary-corporate entity, industry-sector, or other economic relationships in the system being modeled. As a non-limiting example, the assignment of interval or numerical codes to the qualitative data enables the assignment of codes associated with a property to a dimension in coordinate space.

In one embodiment, each property corresponds to a dimension in coordinate space, such that a system with n properties being modeled can be characterized through n-dimensional coordinate space. In other embodiments, certain properties may be assigned to more than one dimension, or characterized without assigning them to coordinate space.

The location in coordinate space can, as a non-limiting example, represent values associated with ordinal or interval variables reflecting order in the underlying system being characterized, including, as non-limiting examples, temporal, spatial, mechanical, relational, or functional order, wherein a function represents the conversion from an input to an output. In certain embodiments, a set of variables may have magnitude and direction, enabling them to be represented as vectors.

In certain embodiments, a set of data entities corresponding to locations in high-dimensional coordinate space can be an input to a coordinate AI module which can, as a non-limiting example, adjust locations in coordinate space to correspond to changes in the complex system being modeled.

### Information Systems

The quantification of properties related to a complex system enables the assignment of data entities in a database to locations associated with quantities in multiple dimensions. In certain embodiments, the quantities can be rendered in coordinate space or vector space.

In other embodiments, they may be rendered, as non-limiting examples, in a matrix, network or graph. In certain embodiments, the direction associated with the coded variable or property can be reflected in a directed graph.

In certain embodiments, the qualitative properties rendered quantitatively can be integrated in the data structure with quantitative data and data from other information systems, including, as non-limiting examples, geographic data rendered as interval variables and market metrics rendered as continuous or interval variables.

The assignment of data entities to locations enables the flexible computation of similarity among entities in a complex system in the information system. In certain embodiments, a stochastic or variable component may be used to account for uncertainties or potential fluctuations associated with divergences or distances between or among properties.

When implemented on a platform, the information system may enable, as a non-limiting example, the quantification of user preferences and characteristics and the standardization of the user preferences and characteristics in a data structure.

### Search and Retrieval

The structures enable search and retrieval operations that facilitate the alignment of user preferences and interest with a set of data entities representing parts of a complex system. In certain embodiments, the search tool can quantify the input provided by a user, weighted by express or implied user preferences, and seek to match it with the quantity in the information system, which may result from filtering, weighting or ranking of the data entities in the information system.

### Ordered Fields

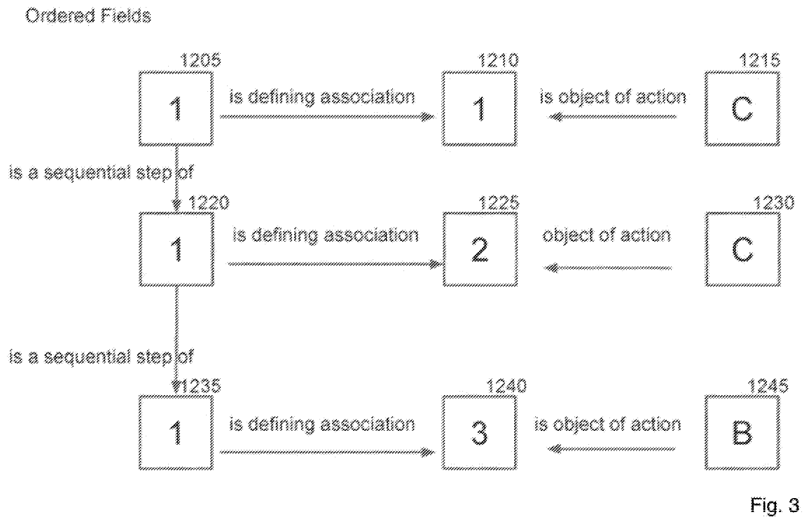

FIG. 3 illustrates an example ordered set of fields showing example relationships between the fields according to the invention. Field 1205 (“1”) is a defining association of Field 1210 (“1”), which jointly describe an action performed upon an object described in Field 1215 (“C”). Fields 1220 and 1225 (“1” and “2” respectively) describe a sequential step of the action described in Fields 1205 and 1210, and describe an action performed upon an object described in Field 1230 (“C”). Field 1235 (“1”) is a sequential step of Field 1220 (“1”), and is a defining association of Field 1240 (“3”), which jointly describe an action performed upon an object described in Field 1245 (“B”). In certain embodiments, a functional proximity algorithm can be configured to compute correspondence based on the magnitude and category of relationships among a plurality of the data entities, such as that between Field 1225 and Field 1215, or Field 1225 and Field 1205.

In certain embodiments, the data structures, methods, and systems described herein may facilitate the more rapid development of indices that match user preferences that prior art methods, including, but not limited to, with respect to themes, quantitative exposures, and target outcomes.

The capacity to unify qualitative and quantitative data using the methods and systems described herein may enable, as non-limiting examples, the association of economic and financial metrics with thematic, sectoral, environmental, social, governance, sustainability, or developmental qualities, properties, or objectives to reflect correlations and relationships within an economic system or financial markets.

As a non-limiting examples, the unified data and capacity for precision, and accuracy; and relational, ordered or networked information with respect to qualities and properties may enable the identification of exposures that are neither entirely systematic with respect to all entities or securities, nor idiosyncratic with respect to an individual entity or security.

Financial metrics and ratios may be assessed with respect to granularly defined segments of the market and compared to existing user holdings and indices so as to align future holdings and indices more closely with user express and/or implied preferences.

### Data Systems for Index Generation

In certain embodiments, the methods and systems described herein may facilitate the rapid, precise generation of indices aligned to user preferences. The coding method may, in certain embodiments, enable the algorithms used to generate the indices to be auditable, transparent, deterministic, and replicable.

In some embodiments, qualitative data is extracted using the methods described herein from unstructured data, including, as non-limiting examples, unstructured economic, financial, regulatory, geographic, or environmental data. In some embodiments, the extraction of qualitative data concerning companies associated with index constituents may be performed through a machine learning technique. As a non-limiting example, a machine learning model may be provided with a training set which maps unstructured data concerning qualitative or quantitative properties to structured categories, including, as non-limiting examples, to product lines, segments, themes, sectors, or environmental, social, or governance exposures. In some embodiments, the structured categories are characterized as numerical values, which may be ordinal variables in a data structure associated with their order in the underlying system. The order may include, as non-limiting examples, supply chain relationships, sector/sub-sector relationships, or financing relationships. The machine learning model may apply the data structure and the training set to classify the unstructured data in a test set into qualitative properties which can be rendered quantitatively.

The techniques described herein may facilitate the standardization of product lines, segments, and themes of companies associated with index constituents.

In some embodiments, the extraction of qualitative data concerning companies associated with index constituents may be performed through a machine learning technique. As a non-limiting example, a machine learning model may be provided with a training set which maps unstructured data concerning qualitative or quantitative properties to structured categories, including, as non-limiting examples, to product lines, segments, themes, sectors, or environmental, social, or governance exposures. In some embodiments, the product lines, segments, or themes may be coded using ordinal or interval variables to reflect order in the underlying system, including, as non-limiting examples, financial, economic or environmental relationships.

In some embodiments, the structured categories are characterized as numerical values, which may be ordinal variables in a data structure associated with their order in the underlying system. The order may include, as non-limiting examples, supply chain relationships, sector/sub-sector relationships, or financing relationships.

### Index Generation

The methods and systems described herein, in certain embodiments, may enable the development of indices on a platform more rapidly, precisely, and accurately with respect to target outcomes, holdings and preferences compared to prior art methods. The platform may, as a non-limiting example, enable indices to be generated principally from the assembly of constituents, individual components, data entities, securities, or clusters. As non-limiting examples, the platform may facilitate the generation of thematic, factor, impact, and/or core or benchmark indices.

In certain embodiments, the index generation platform may operate through a plurality of modules. The platform can aggregate n data sets, represented in FIG. 1 as data set 1 101, data set 2 102, through data set n 105, into a data module. The data sets may be structured or unstructured.

As non-limiting examples, the data sets may reflect financial, economic, thematic, sectoral, quantitative, geographic, environmental, social, governance, sustainability, or developmental data.

The platform can apply, in certain embodiments and as non-limiting examples, a logical data model; data structures reflecting order in the domains or systems characterized by the data; and machine learning techniques related to the classification of unstructured data, or data structured by prior art systems, into the logical data model or the data structures, to extract information from the data sets 110.

In certain embodiments, the platform can identify qualitative properties associated with the data 125 reflecting, as non-limiting examples, themes, industries, economic relationships, and geographic locations. As non-limiting examples, a regulatory filing may identify product lines, geographic sources of revenue, suppliers, and financial metrics associated with a company.

The platform, in certain embodiments, can 135 convert the qualitative properties to quantitative properties 145 through, as non-limiting examples, ordinal coding or interval variables reflecting the relationships in the system associated with the data set and the qualitative properties. As a non-limiting example, a producer, distributor, and purchaser of machinery to manufacture tractors, and a company buying tractors, may have successive numerical codes in one dimension in the system by virtue of their supply chain relationships and would share a numerical code in another dimension with one another and with food companies identifying a connection to the agricultural sector.

The platform can also extract quantitative properties 155 from the data, including, as non-limiting examples, market metrics, financial metrics and economic metrics. In certain embodiments, the platform can associate the quantitative properties with qualitative properties, including, as a non-limiting example, by extracting information concerning a product line from a regulatory filing, standardizing it using ordinal coding, and connecting it to the percentage exposure of a company to the product line and to other securities or companies with identical or similar exposures, product lines or codes.

In certain embodiments, the platform can unify the quantitative data and the qualitative data rendered quantitatively 160 into an integrated framework. In certain embodiments, the data, or subsets thereof, can be rendered as one or more mathematical structures, including, as non-limiting examples, a high-dimensional coordinate space, a tensor space, a vector space, a graph, or a matrix.

The framework enables, in certain embodiments, the rapid computation of similarity or distance between entities, elements, or constituents of an index connected to properties associated with data entities; search and retrieval operations related to constituents; and the capacity for the platform to generate indices aligned with user preferences. In certain embodiments, the preferences may be express and determined, as non-limiting examples, through queries or questions; in other embodiments, the preferences may be implied and determined, as non-limiting examples, based on platform usage or the preferences of similar users.

The platform includes, in certain embodiments, index construction parameters associated with a user 170 that may include, as non-limiting examples, user preferences related to themes; sectors; index weighting; index constituents; index rebalancing; dividend treatment; security exclusion and inclusion; quantitative factors; tax management; geographic regions; existing holdings; demographic information; or financial objectives.

In certain embodiments, user-associated index construction parameters 170 are rendered quantitatively or ordinally to facilitate association with the unified qualitative and quantitative data 160 and enable index generation.

In certain embodiments, the unified data sets 160 and user-associated index construction parameters 170 are inputs to the generation of a customized index 180. An index generation algorithm may, as a non-limiting example, take a primary index construction parameter from a user, apply it to select a set of potential constituents from the integrated database, filter the constituents based on user conviction or sentiment and its alignment with the unified quantitative data 160, apply additional filtering based on a second index construction parameter associated with the user, weight constituents based on preferences associated with the user, remove or add a set of constituents based on user preferences, and reweight the constituents to derive an index.

### Thematic Indices

As a non-limiting example, the platform may enable the generation of indices based on a theme aligned with user preferences. In certain embodiments, the themes may be selected from among, as non-limiting examples, macroeconomic themes, such as resistance to inflation or recession, and microeconomic themes, such as water or cybersecurity.

In some embodiments, a metric or score is computed with respect to a theme. In one embodiment, an ordinal or interval variable is assigned with respect to the extent of the centrality of a theme to a product, product line, subsector, or segment of the economy.

A security may be associated with a plurality of segments, products, product lines, or exposures. In some embodiments, the thematic indices module may algorithmically compute the association of a theme with a security based on the proportions of segments, products, product lines or exposures. As non-limiting examples, a thematic algorithm may weight or score securities based on the centrality and percentage or magnitude of association of segments, products, product lines, and exposures to the themes in the thematic data module. The algorithm may characterize the exposure on an absolute basis or relative to the exposures of other securities, data entities or constituents in the database. The magnitude may be quantified, in certain embodiments, by a financial, market, or economic metric, selected from among, as non-limiting examples, revenue, net income or loan portfolio. As non-limiting examples, the output of the thematic algorithm may include one or more scores with respect to the magnitude and percentage of exposure to the theme.

In certain embodiments, the sentiment or conviction of the user with respect to a theme may affect the weighting of the component scores of the output of the thematic algorithm to derive thematic scores. As non-limiting examples, the extent of sentiment or conviction of the user may be reflected through the assignment of an ordinal or continuous variable. In one embodiment, the greater the conviction or sentiment of a user towards a theme, the more weight is assigned to the percentage exposure to the theme and the less weight is assigned to the magnitude of exposure to the theme to derive a score or quantity associated with a level or degree of conviction.

In certain embodiments, indices for a theme, including, as non-limiting examples, macroeconomic or microeconomic themes, can be generated based on the scores related to thematic exposures.

In one embodiment, a thematic index generation algorithm takes as input a user's level of sentiment or conviction in a theme, a user's target number of entities or constituents, and a market metric, including, as a non-limiting example, liquidity, and applies the market metric to reduce the set of entities eligible for an index. The algorithm then ranks the eligible entities by score associated with the user preference related to a level of conviction, and reduces the number of constituents or entities by eliminating the entities whose rank with respect to thematic score falls below the target count of number of entities.

The thematic index generation algorithm then weights the entities or constituents by thematic score associated with the user's preferred conviction or sentiment level. In certain embodiments, the algorithm adjusts the weights by capping the weight of individual constituents based on an algorithm that assigns a maximum weight to index constituents based on data associated with the index. In one embodiment, the algorithm then applies entity or constituent exclusions or inclusions based on user preferences, and reweights the portfolio accordingly.

In one embodiment, the thematic index generation algorithm can be applied to create a multi-thematic index. The algorithm may, in certain embodiments, include constituents for a user for each theme whose thematic score for a pairing of a user-preferred theme and conviction level ranks above the quotient of the target count and the number of user-preferred themes. The algorithm, in one embodiment, may weight each thematic component of a multi-thematic index as a function of the number of themes. In certain embodiments, the weight of each thematic component may be equal to the weight of the index divided by the number of themes. In certain embodiments, a constituent that aligns with multiple themes in a multi-thematic index may have a weight that exceeds the weight that would be specified by a capping table in a single-theme index.

### Factor Indices

In certain embodiments, the platform may facilitate the generation of indices based on one or more quantitative factors. In some embodiments, the factors may include, as non-limiting examples, value, growth, quality, dividend yield, price momentum, leverage, volatility, and earnings momentum. In other embodiments, the factors may include, as non-limiting examples, capital strength, free cash flow, or enterprise value.

A set of algorithms, as non-limiting examples, may be applied to market metrics or financial metrics associated with a security to derive one or more factor scores associated with a given factor and security. As non-limiting examples, in certain embodiments, growth scores may be computed based on future long-term projected earnings growth, future short-term projected carnings growth, current investments to assets, historical return on assets, other growth-related metrics, or a combination thereof. In certain embodiments, factor scores may be normalized with respect to the scores of other constituents.

In certain embodiments, a factor index generation algorithm may take as inputs the extent of conviction or sentiment of a user with respect to a factor, a user's target number of entities or constituents, and a market metric, including, as a non-limiting example, liquidity, and then apply the market metric to reduce the set of entities eligible for an index. The algorithm then ranks the eligible entities by score associated with the user preference related to a level of user conviction or sentiment.

In one embodiment, beyond a certain conviction or sentiment threshold, the algorithm reduces the number of constituents or entities by selecting the entities by rank with respect to factor scores until the target count of number of entities is reached.

At a lower conviction or sentiment threshold, in one embodiment, the algorithm takes as additional input a qualitative property associated with the constituents or entities, which may, in certain embodiments, be selected from among sector or theme, and may be rendered quantitatively. The algorithm then assigns weights across sectors or themes, which may, in one embodiment, be proportional to the weight of the sector or theme in the universe of constituents, and reduces the number of constituents by selecting constituents according to the factor rank by sector or theme until the target weight is reached by sector or theme, with the number of constituents by sector rounded, in certain embodiments, to an integer value. In one embodiment, if a user prefers to exclude one or more sectors, then the weights of remaining sectors are first adjusted proportionally.

In certain embodiments, the algorithm adjusts the weights by applying a user-preferred weighting methodology and then capping the weight of individual constituents based on an algorithm that assigns a maximum weight to index constituents based on data associated with the index. In one embodiment, the algorithm then applies entity or constituent exclusions or inclusions based on user preferences, and reweights the portfolio accordingly.

In one embodiment, at an intermediate level of conviction or sentiment, the factor index generation algorithm sequentially applies the procedure to generate and average multiple factor indices, which may include, in certain embodiments, a low and a high conviction or sentiment factor index. The algorithm ranks the constituents by their average weight across the multiple indices and reduces the number of constituents or entities by selecting the entities by rank with respect to factor scores until the user preference for the target count of number of entities is reached. In some embodiments, the factor index generation algorithm then reweights the constituents proportional to their average weight, and adjusts the weights by capping the weight of individual constituents based on an algorithm that assigns a maximum weight to index constituents based on data associated with the index.

In certain embodiments, the factor index generation algorithm can be applied to construct a multi-factor index by weighting or averaging the factor scores across a user's preferred factors and applying the weighted or averaged factor score across the factor index construction methodologies at a given conviction level.

In certain embodiments, the factor index generation algorithm can be applied to multiple user-preferred factors sequentially to create a multi-factor index. The multi-factor index generation algorithm may take as inputs the extent of conviction or sentiment of a user with respect to multiple factors, a user's target number of entities or constituents, and a market metric, including, as a non-limiting example, liquidity, and applies the market metric to reduce the set of entities eligible for an index. The algorithm then ranks the eligible entities by score associated with a first user-preferred factor and the user preference related to a level of user conviction or sentiment.

At a lower conviction or sentiment level for a sequential multi-factor index, in one embodiment, the algorithm takes as additional input a qualitative property associated with the constituents or entities, which may, in certain embodiments, be selected from among sector or theme, and may be rendered quantitatively. The algorithm then assigns weights across sectors or themes, which may, in one embodiment, be proportional to the weight of the sector or theme in the universe of constituents, and reduces the number of constituents by selecting constituents according to the factor rank of the first factor by sector or theme until the target weight is reached by sector or theme, with the number of constituents by sector rounded, in certain embodiments, to an integer value. In one embodiment, if a user prefers to exclude one or more sectors, then the weights of remaining sectors are first adjusted proportionally.

At the lower conviction or sentiment level, the algorithm would then rank constituents across a plurality of sectors or themes by their scores with respect to the second factor, and weight the constituents according to a user-specified method.

The algorithm then assigns weights across sectors or themes, which may, in one embodiment, be proportional to the weight of the sector or theme in the universe of constituents, and reduces the number of constituents by selecting constituents according to the factor rank by sector or theme until the target weight is reached by sector or theme, with the number of constituents by sector rounded, in certain embodiments, to an integer value. In one embodiment, if a user prefers to exclude one or more sectors, then the weights of remaining sectors are first adjusted proportionally.

In certain embodiments, the algorithm adjusts the weights by applying a user-preferred weighting methodology and then capping the weight of individual constituents based on an algorithm that assigns a maximum weight to index constituents based on data associated with the index. In one embodiment, the algorithm then applies entity or constituent exclusions or inclusions based on user preferences, and reweights the index accordingly.

At a higher level of user conviction or sentiment with respect to factors in a multi-factor index, the algorithm, in certain embodiments, selects constituents ranked by the first user-preferred factor until a multiple of the user-preferred target count is reached. The algorithm then may weight the constituents, in certain embodiments, by a function of the multiple factor scores and, as a non-limiting example, a market metric. In one embodiment, where n is the number of factors chosen and i is the sequence number of the Factor when counting from the lowest-weighted to the highest-weighted, the weight of each Factor may be calculated, as a non-limiting example, as equal to 2i/(n2+n).

In certain embodiments, the algorithm adjusts the weights by applying a user-preferred weighting methodology and then capping the weight of individual constituents based on an algorithm that assigns a maximum weight to index constituents based on data associated with the index. In one embodiment, the algorithm then applies entity or constituent exclusions or inclusions based on user preferences, and reweights the portfolio accordingly.

At an intermediate level of sentiment or conviction with respect to factors in a multi-factor index, the algorithm may, in one embodiment, apply an average or a weighted average of lower sentiment or conviction and higher sentiment or conviction indices.

In certain embodiments, a user may seek a factor overlay for an index. A factor overlay generation algorithm may be applied which takes as input the constituents and weights from an index generated by the platform.

In certain embodiments, the algorithm can take as input a factor score associated with the constituents of the index and reweight the constituents proportionally to the factor score. The algorithm, in certain embodiments, may then adjust the weights by applying a user-preferred weighting methodology and then apply a capping methodology by capping the weight of individual constituents based on an algorithm that assigns a maximum weight to index constituents based on data associated with the index. In one embodiment, the algorithm then applies an inclusion and exclusion method for entity or constituent exclusions or inclusions based on user preferences, and reweights the portfolio accordingly.

### Impact Indices

In certain embodiments, the platform may enable the generation of indices targeted towards one or more user impact preferences selected from among, as non-limiting examples, environmental, social, governance (ESG) focused, or Sustainable Developmental Goal (SDG) focused.

An impact index algorithm, in certain embodiments, may take as input a set of metrics associated with constituents and their scores on, as non-limiting examples, one or more ESG or SDG properties, a level of user sentiment or conviction regarding the impact properties, and a set of categories of constituents, including, as non-limiting examples, sectors or industries, that a user prefers to exclude.

The algorithm may, in certain embodiments, exclude the sectors or industries indicated by a user and constituents associated with a market metric, including, as a non-limiting example, liquidity, that falls below a specified threshold.

At a lower level of user conviction or sentiment, the algorithm, in certain embodiments, takes as additional input a qualitative property associated with the constituents or entities, which may, in certain embodiments, be selected from among sector or theme, and may be rendered quantitatively. The algorithm then ranks constituents by their ESG or SDG score.

In one embodiment, beyond a certain conviction or sentiment threshold, the algorithm reduces the number of constituents or entities by selecting the entities by rank with respect to ESG or SDG scores until the target count of number of entities is reached. The algorithm then weights the constituents by a function of their ESG or SDG scores and, in certain embodiments, a weighting metric specified by the user. The algorithm may then, in certain embodiments, apply the capping methodology and the inclusion and exclusion methodology.

At a lower conviction or sentiment threshold, in one embodiment, the algorithm takes as additional input a qualitative property associated with the constituents or entities, which may, in certain embodiments, be selected from among sector or theme, and may be rendered quantitatively. The algorithm then assigns weights across sectors or themes, which may, in one embodiment, be proportional to the weight of the sector or theme in the universe of constituents, and reduces the number of constituents by selecting constituents according to the ESG or SDG rank by sector or theme until the target weight is reached by sector or theme, with the number of constituents by sector rounded, in certain embodiments, to an integer value. In one embodiment, if a user prefers to exclude one or more sectors, then the weights of remaining sectors are first adjusted proportionally.

### Core Indices

In certain embodiments, the platform can be used to generate narrow indices aligned to user preferences with similar performance characteristics to those of a broad index, which may facilitate the implementation of an index product or strategy.

In certain embodiments, the platform enables core index generation by first identifying a broad index from which to select constituents. The platform may, as a non-limiting example, provide for user preferences for the exclusion or reweighting of sectors or subsectors for the core index, and determine user preferences regarding the maximum number of securities in an index.

As non-limiting examples, the platform may enable the user to select a preferred rebalancing frequency and treatment of dividends in the core index. In certain embodiments, the platform may provide for user preferences regarding impact overlays, thematic tilts or quantitative factor tilts to be applied to the core index. The platform may, as a non-limiting example, additionally provide for user preferences regarding constituent exclusion or inclusion, or for tax management.

The platform may, in certain embodiments, use a core index generation algorithm that takes as inputs user preferences to identify a baseline broad index, exclude specific sectors, and reduce the constituents to the target count through an optimization technique or statistical method, including, as a non-limiting example, stratified sampling.

The algorithm may then apply sector weights, factor tilts, thematic tilts, and impact overlays, and remove excluded securities, with the possibility for iteration and reweighting to develop a core index aligned with user preferences.

### Benchmark Indices

In certain embodiments, the platform may provide for the modification of broad-based indices in alignment with user preferences. A benchmark index generation algorithm may, in certain embodiments, take user preferences as inputs to identify a universe of constituents and exclude specific sectors, then apply preferences regarding sector weighting, factor tilts, thematic tilts, and impact overlays. The algorithm may then, as non-limiting examples, include or exclude specific securities based on user preferences to create the benchmark index.

### Existing Indices

In certain embodiments, the platform may enable users to select existing indices for implementation into an index product. As a non-limiting example, the platform may iterate through indices previously provided to the platform, or previously generated on the platform, and order them in a user interface based on, as non-limiting examples, statistical metrics, index categories, recency of creation, or alignment with user preferences.

### Search

In certain embodiments, the platform may provide for search through natural language or another medium to facilitate the generation of indices. The platform may infer user preferences related to, as non-limiting examples, theme, sector, and conviction level based on user search terms and history, and use the search data to more rapidly generate indices aligned with user preferences. In some embodiments, natural language processing techniques are used to generate indices aligned with user search terms.

### Rulebook

In certain embodiments, the platform can include a module that algorithmically generates output enumerating user preferences and the methodology used by the platform to generate indices. The module may, in one embodiment, be designed to align with rules and data regarding publication of information necessary for legal and regulatory purposes.

### Index Reporting

The platform facilitates the assessment of indices and implementation into products at scale by integrating, as non-limiting examples, statistical, methodological, regulatory, and operational information related to the indices.

In certain embodiments, the platform can compute statistical information related to an index generated for a user. As a non-limiting example, the system may compute the historical market performance of the index based on, as non-limiting examples, rules delineating the composition of the index; the exposure of the index to themes, factors, or ESG properties; and the frequency of rebalancing and reconstitution.

The integration of qualitative and quantitative data with user data using the methods described herein may facilitate the generation of backtested information concerning an index more rapidly than prior art methods.

### Iterative Index Development

In certain embodiments, the systems and methods described herein may facilitate the rapid iterative development of indices. The centralization and integration of modules, data, data structures, and algorithms for index generation may allow a user to assess rapidly the prospective effects of preferences or decisions concerning an index, and to modify such preferences or decisions based on statistical information associated with the index.

The platform may enable a user to converge rapidly on one or more indices consistent with preferences, and to allow, as a non-limiting example, an advisor to users of indices or index-based products to assess, test, implement and manage indices and products based on indices for numerous users in real time.

### Simulations

In certain embodiments, the platform may include a module that simulates the results of a set of indices which align with user preferences. The platform may, in one embodiment, enable the user to select from among multiple indices or index variants which are aligned with user preferences based on testing results, analytics or performance characteristics.

### Recommendations

In one embodiment, the platform may provide recommendations to a user regarding indices that reflect alignment with user preferences. In one embodiment, the platform may include a recommendation engine that takes as inputs, as non-limiting examples, user search terms, search terms from similar users, indices previously selected by a user, indices selected by similar users, market data, index properties, index data, and qualitative properties and applies a recommendation algorithm to the input data to generate one or more indices to recommend to a user based on alignment between indices and user preferences. In certain embodiments, index generation algorithms may provide for the creation of a set of indices aligned with user preferences and recommend or select one or more for a user, which may be based, as non-limiting examples on simulation, performance characteristics, or relative strength of user preferences.

### Custom Analytics

In certain embodiments, the platform may facilitate user-created statistics concerning index performance and characteristics, including, but not limited to, the provision of customized market, financial, or economic metrics or customized thematic, factor, geographic, or ESG or SDG exposures for one or more indices, users, or clients. As a non-limiting example, the platform may determine from a user's express preferences or queries their interest in a metric, such as realized yield, or theme, such as neurological therapeutics, that is not otherwise provided as a standardized report to users, and may provide the data concerning such metric or theme to a user.

In some embodiments, the platform may provide a formula or theme builder to users to enable them to design their own analytical reports, which may enable the user, as a non-limiting example, to request the generation of indices based on the analytics and, as a non-limiting example, a customized theme of interest.

### Index Marketplace

In certain embodiments, the systems and methods can include a marketplace for system users to publish customized indices for use by other authorized users of the system. The system can include an interface that presents certain performance metrics of indices that users have generated. The system can compare the performance of custom indices created by any users to the performance of all other custom indices, and, as a non-limiting example, identify ones that statistically outperform other indices created by other users in the system. Those identified indices created by a user can then be suggested to that user for publication on the index marketplace. The system can be configured so that indices published on the marketplace can be licensed by other users and incorporated into their own profiles and offered to their own clients or third parties. The system can be configured to offer other users on the platform the opportunity to license indices recommended to them based on the statistical performance of those indices. The system can be further configured to coordinate the licensing arrangements between users, provide for a price discovery mechanism, or facilitate the exchange of indices or rights to indices among users.

In some embodiments, the system can be configured so that users on platform have a stored user profile which is configured to include information associated with the customized indices, including the status of indices in process of being developed, indices approved by clients, and indices in production. Additionally, indices that a user has in-licensed for offering to their clients can be included in the user profile data block.

### Institutional and Retail Platforms

In certain embodiments, the systems and methods described herein may enable the development of platforms for institutional use, for advisors managing or recommending index-based products on behalf of clients, and for retail use, for the generation of indices for users to implement directly into index-based products on their own behalf.

In some embodiments, a platform can provide for institutional and retail use, enabling the transmission of data between an advisor, client or user, and the platform to facilitate the rapid generation of indices aligned to user preferences.

### Additional Platform Integrations

The methods and systems characterized herein may be designed, in certain embodiments, to enable the integration of the platform with additional modules or platforms related to operational implementation of indices for users at scale.

### Tax Management

In certain embodiments, the platform may include a module providing for tax management associated with the implementation of the index into a product. The tax management module may include, as non-limiting examples, information concerning a user's holdings and data regarding tax regulations, and may algorithmically modify an index for a user based on tax considerations.

In some embodiments, the systems and methods characterized herein may facilitate tax-managed solutions in a rapid, efficient manner. As a non-limiting example, the flexibility with which themes and sectors can be characterized and the capacity to determine similarity across multiple dimensions between constituents may enable the substitution of constituents in an index that are similar to those excluded from a user's index for tax purposes, with a similarity score that can be customized to a user based on user preferences. In certain embodiments, a tax management module may be connected with a regulatory and legal module or may include input from an individual with tax expertise.

### Advisory Software

In certain embodiments, the platform can include or be integrated with software for advisors to manage products based on indices together with other holdings. The advisory software may enable the integration of data concerning client holdings with data on indices and their constituents to inform the generation, implementation, and management of products based on indices that are customized to user or client needs and reflect the effect of new index-based products on overall holdings. The integration also may facilitate real-time, flexible client account management by an advisor or user based on market movements and changes in user preferences.

### Customer Relationship Management

In certain embodiments, the methods and systems described herein may enable the integration or incorporation of customer relationship management software into an index platform, which would enable an advisor or user to communicate to clients regarding prospective products based on indices. The integration, in one embodiment, may enable the incorporation of data, including, as non-limiting examples, demographic data, client history, and communication history with a client or user to inform the generation of indices aligned with user preferences.

### Trading Platform

In certain embodiments, the methods and systems described herein may include the integration or incorporation of a trading platform or trading software with an index generation platform. The integration or incorporation may enable advisors or users to implement the development of index-based products in an efficient, real-time manner, and to incorporate data concerning frictions in implementing index products into the generation of indices. As a non-limiting example, data concerning the liquidity of an instrument or security on a platform may be used to facilitate the substitution of similar constituents within an index to enable efficient implementation.

### Custody Platform

The methods and systems described herein, in certain embodiments, may provide for the integration or incorporation of a custody platform to facilitate the tracking, auditability, administration, and oversight by users or advisors over products based on indices generated on the platform. The data from the custody platform concerning holdings may inform, in certain embodiments, the generation of indices customized to user preferences.

### Compliance Software

In certain embodiments, the platform may incorporate or be integrated with software to assess compliance of implementation with index-based products. As a non-limiting example, the compliance software may be used to verify that a prospective trade in a company's security associated with a constituent of an index is consistent with laws and regulations concerning the eligibility of an individual associated with the company to trade the security in a personal account, either generally or at particular time frames near corporate events.

In certain embodiments, data from the compliance software concerning the capacity of users to trade in one or more securities associated with constituents, and thereby implement a strategy, may be used to exclude constituents from an index on the index generation module and substitute a similar constituent based on information from the database of similar entities on the platform.

### Accounting and Billing Software

In certain embodiments, the platform may provide for the integration of software for accounting and billing to enable a user to assess, track and manage in real-time payments due for index-based products. The accounting and billing software may take as inputs from the platform data concerning users or clients, their index products, the date of implementation, and assets and fees associated with such index-based products to create statements concerning client obligations. In some embodiments, the accounting and billing software may aggregate such data and provide it as an input to the platform to facilitate the assessment by the platform of the success of a product associated with an index.

### Dynamic Asset Allocation

In certain embodiments, the platform may facilitate the conversion and revision of indices to products to transition asset allocation dynamically by enabling real-time editing of indices with updated analytics, which may be beneficial, as non-limiting examples, in a rapidly moving market environment, in response to geopolitical or macroeconomic events, or due to significant changes in personal preferences.

### Stratified Sampling and Optimizations

In certain embodiments, a multi-step process is employed to create an index using a statistical technique, including, as a non-limiting example, stratified sampling, to construct an index consisting of fewer constituents than an original user-specified index or benchmark. An example optimization process can include, as non-limiting examples, one or more of the following steps, including, but not limited to, iteratively, in the order below, or in an alternate order:
1. Divide the benchmark into a specified number of groups, such as quartiles, by count.
2. Calculate the total weight of each of the groups in the benchmark.
3. Calculate the reduced number of securities to be selected from each of the groups in the stratified index.
4. In certain embodiments, for all the securities or constituents listed in each quartile, apply one or more metrics (which, as non-representative examples, may comprise market capitalization, beta, volatility, or tracking error) to determine which securities are to be included in the stratified index to match the numbers identified in #3 above.
5. Weight the selected securities in each sector based on their weights in the benchmark (either modified market cap or modified equal weight, depending on the benchmark).
6. Modify these weights by the corresponding sector weight in the benchmark.
7. Assess the turnover and tracking error associated with implementation of the optimization process.

### System Architectures

The system, method and platform described herein can be implemented in software, hardware, or any combination thereof. An embodiment of the platform is described herein, in being understood that the characterization of the platform, system and methods includes non-limiting examples of implementation decisions and can be implemented in alternate embodiments.

In one embodiment, a server infrastructure for the platform may include a tool for managing distributed services across multiple services transparently and facilitating horizontal scaling and redundancy. As a non-limiting example, the tool may be a Kubernetes Cluster. In one embodiment, the Kubernetes Cluster includes a control plane and nodes to manage where services run, their health and the underlying servers.

In one embodiment, the server infrastructure can include a load balancer to distribute requests between different services and service instances, facilitating the horizontal scaling of services.

The nodes and load balancer, in one embodiment, can be an input to service pods or service instances to enhance throughput and resiliency. The service pods may include, as non-limiting examples, an index engine, a data loader, a remote procedure call framework index service, and a portal front end.

The server infrastructure may, in certain embodiments, provide for initial monitoring which may use a log aggregation system, including, as a non-representative example, Loki, to gather metrics and logs, visualize metrics, and provide altering on metric irregularities.

The server infrastructure may, in certain embodiments, provide for a virtual private network (VPN) access to facilitate access to the non-production environment, the application database, and metrics services.

In certain embodiments, the server infrastructure may provide for a virtual private cloud to provide access to non-load balanced services.

The server infrastructure may, in certain embodiments, include an application database to facilitate point-in-time recovery and scalability and reduce maintenance burden.

In certain embodiments, the server infrastructure can include a mail service to provide for encrypted mail with enhanced security defaults.

In certain embodiments, the server infrastructure can include a package for error monitoring, reporting, and resolution.

### Backend Systems

The backend systems are designed to facilitate scaling of index generation in real time and on demand. The systems may, in some embodiments, be designed for horizontal and vertical scaling.

### Networking

In one embodiment, the platform provides for region failover with a specific cloud service provider, which enables access to the application when service is disrupted in a particular region. In the case of interruption of an original provider's services, a second cloud service provider can be used to minimize downtime. In one embodiment, this can be duplicated across regions to increase performance and decrease downtime.

### Cybersecurity

The platform traffic is encrypted. User information is encrypted at rest. An automated password rotation system may be deployed, with a set of security practices on user passwords or logins.

### Data Models

In one embodiment, the system uses a data architecture that reflects the underlying order in the system being modeled, including, as non-limiting examples, through input-output relationships, that integrate qualitative and quantitative data in a unified data structure to facilitate search, retrieval and index generation operations.

### Data Storage

In one embodiment, back-end data is stored on a PostGres database, with in-memory caching on the client.

Multiple PostGres databases are used, in certain embodiments, to store data, one for storing client information, a second for a centralized data store system, which includes data provided by third parties. In certain embodiments, master databases and mirror databases supporting different sets of users, enabling sharding, may permit rapid index generation at scale.

### Programming Languages

In one embodiment, the front end of the platform is written in Typescript, using a framework named React, which communicates with a back-end index engine and the back end of the platform is written in C++ and communicates with a Postgres database. In certain embodiments, a back-end aspect of the platform is written in Ruby on Rails, which communicates with the front-end engine and has its own Postgres database. In implementations on mobile devices, the platform may be written, as non-limiting examples, using Swift, Java, and Kotlin. In other embodiments, alternate programming languages may be used.

### Communication

In certain embodiments, communication is facilitated through GRPC, a secure data transfer protocol and remote procedure protocol.

### Devices

In one embodiment, the platform is accessible through desktop and mobile platforms and internet browsers. In another embodiment, the platform is accessible through native mobile applications, including smartphone devices.

### Front End

In one embodiment, the front end is written as a single page app to facilitate rapid index generation; time-consuming tasks are moved to the backend to enable the front end.

### End-to-End Testing

The platform, in one embodiment, provides for running through the app on a live server to test that the systems are working accurately and prevent regressions.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized, and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood such methods can be computer implemented methods (e.g., instructions stored in memory and executed on processors). Where methods described above indicate certain events occurring in certain order, the ordering of certain events can be modified. Additionally, certain events can be performed repeatedly, concurrently in a parallel process when possible, as well as performed sequentially as described above. Furthermore, certain embodiments can omit one or more described events.

Some embodiments described herein relate to a computer storage product with a non-transitory computer-readable medium (also can be referred to as a non-transitory processor-readable medium) containing instructions or computer code for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages, functional programming languages, logical programming languages, object-oriented programming languages, or other suitable programming languages and/or development tools. Additional examples of computer code include, but are not limited to, control signals, encrypted code, and compressed code.

In order to address various issues and advance the art, the entirety of this application (including the Cover Page, Title, Headings, Background, Summary, Brief Description of the Drawings, Detailed Description, Claims, Abstract, Figures, Appendices, and otherwise) shows, by way of illustration, various embodiments in which the claimed innovations can be practiced. The advantages and features of the application are of a representative sample of embodiments only and are not exhaustive and/or exclusive. They are presented to assist in understanding the claimed principles.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

1. A computer-implemented method for creating a customized index, the method comprising:
storing data from multiple disparate data sets, the disparate data sets including both qualitative properties and quantitative properties associated with the data entities;
selecting an algorithm that renders qualitative properties quantitatively;
applying the selected algorithm to the qualitative properties to convert the qualitative properties into quantitative data;
selecting a data structure that unifies quantitative data associated with the disparate data sets;
applying the data structure to integrate the quantitative data with the quantitative properties associated with the data entities, thereby creating a unified quantitative data set;
associating the data entities with the unified quantitative data set with a logical database structure;
receiving index construction parameters associated with a user;
selecting a generative algorithm that combines data entities associated with quantitative data;
applying the generative algorithm to the unified quantitative data set to create a customized index of data entities; and
storing the customized index of data entities in a database.

2. The method of claim 1, wherein the index construction parameters are qualitative and quantitative, further comprising:
algorithmically computing a similarity metric between the index construction parameters and the unified quantitative data set;
providing the similarity metric as an input to the generative algorithm;
selecting a second algorithm that renders qualitative properties quantitatively;
applying the second algorithm to the qualitative index construction parameters to convert the qualitative properties into a second set of quantitative data;
selecting a second data structure that unifies quantitative data associated with disparate data sets;
applying the second data structure to integrate the second set of quantitative data with the quantitative index construction parameters, thereby creating a second unified quantitative data set; and
algorithmically computing a second similarity metric between the first unified quantitative data set and the second unified quantitative data set.

3. The method of claim 1, further comprising:
algorithmically computing a third similarity metric between the customized index of data entities and the second unified quantitative data set; and
verifying that the third similarity metric is greater than the second similarity metric under fluctuations in parameters associated with the qualitative properties and quantitative properties, as determined by a test of statistical significance.

4. The method of claim 1, wherein:
a. the customized index is a financial index;
b. the data entities represent investment securities; a plurality of the quantitative properties are selected from among market metrics, financial metrics, financial ratios, and economic metrics; and
c. a plurality of the qualitative properties are selected from among sector, industry, geography, theme, environmental sustainability, social sustainability, governance, and economic properties.

5. The method of claim 1, further comprising algorithmically converting the unified quantitative data set into a matrix, network, or high-dimensional coordinate data structure.

6. The method of claim 1, further comprising applying a data structure based on ordinal coding or interval variables as an input to the algorithm that renders qualitative properties quantitatively, wherein the ordinal coding or interval variables are based on relationships modeled in an underlying system.

7. A computer-implemented system for creating a customized index, the system comprising a computerized processor configured for:
storing data from multiple disparate data sets, the disparate data sets including both qualitative properties and quantitative properties associated with the data entities;
selecting an algorithm that renders qualitative properties quantitatively;
applying the algorithm to the qualitative properties to convert the qualitative properties into quantitative data;
selecting a data structure that unifies quantitative data associated with disparate data sets;
applying the data structure to integrate the quantitative data with the quantitative properties associated with the data entities, thereby creating a unified quantitative data set;
associating the data entities with the unified quantitative data set with a logical database structure;
receiving index construction parameters associated with a user;
selecting a generative algorithm that combines data entities associated with quantitative data;
applying the generative algorithm to the unified quantitative data set to create a customized index of data entities; and
storing the customized index of data entities in a database.

8. The system of claim 7, wherein the index construction parameters are qualitative and quantitative, further comprising instructions for:
algorithmically computing a similarity metric between the index construction parameters and the unified quantitative data set;
providing the similarity metric as an input to the generative algorithm;
selecting a second algorithm that renders qualitative properties quantitatively;
applying the second algorithm to the qualitative index construction parameters to convert the qualitative properties into a second set of quantitative data;
selecting a second data structure that unifies quantitative data associated with disparate data sets;
applying the second data structure to integrate the second set of quantitative data with the quantitative index construction parameters, thereby creating a second unified quantitative data set; and
algorithmically computing a second similarity metric between the first unified quantitative data set and the second unified quantitative data set.

9. The method of claim 7, further comprising:
algorithmically computing a third similarity metric between the customized index of data entities and the second unified quantitative data set; and
verifying that the third similarity metric is greater than the second similarity metric under fluctuations in parameters associated with the qualitative properties and quantitative properties, as determined by a test of statistical significance.

10. The system of claim 7, wherein the customized index is a financial index; the data entities represent investment securities; a plurality of the quantitative properties are selected from among market metrics, financial metrics, financial ratios, and economic metrics; and a plurality of the qualitative properties are selected from among sector, industry, geography, economic, theme, environmental, social, and governance properties.

11. The system of claim 7, further comprising instruction for algorithmically converting the unified quantitative data set into a matrix, network, or high-dimensional coordinate data structure.

12. The system of claim 7, further comprising instructions for applying a data structure based on ordinal coding or interval variables as an input to the algorithm that renders qualitative properties quantitatively, wherein the ordinal coding or interval variables are based on relationships modeled in an underlying system.

13. A computer-implemented method for creating a customized index of investment securities, comprising the steps of:
a. storing financial data from multiple disparate data sets;
b. extracting information concerning a set of investment securities from a database, said information being obtained from the disparate data sets, the disparate data sets including both qualitative and quantitative properties associated with the investment securities;
c. converting the qualitative properties to quantitative properties by an ordinal coding technique;
d. unifying the disparate data sets into a unified data set of quantitative properties associated with the investment securities;
e. associating the investment securities with the unified quantitative properties within a logical database structure;
f. receiving user-configured index construction parameters;
g. determining the composition of a subset index of investment securities;
h. constructing a customized index of investment securities based on the user-configured portfolio construction parameters; and
i. storing the customized index of investment securities in an index database.
